(19) United States
(12) Patent Application Publication
(10) Pub. No.: US 2022/0410749 A1
(43) Pub. Date: Dec. 29, 2022

(54) ELECTRIC DEVICE FOR ENERGY CONTROL

(71) Applicant: QOVOLTIS, Montrouge (FR)

(72) Inventor: Ehsan EMAMI, Montrouge (FR)

(73) Assignee: QOVOLTIS, Montrouge (FR)

(21) Appl. No.: 17/767,015

(22) PCT Filed: Oct. 7, 2020
(86) PCT No.: PCT/EP2020/078147

§ 371 Date: Sep. 1, 2022

(30) Foreign Application Priority Data
Oct. 7, 2019 (FR) FR1911083

(51) Int. Cl. B60L 53/62; B60L 53/63; B60L 53/66

(52) U.S. Cl. CPC B60L 53/62; B60L 53/63; B60L 53/665

(57) ABSTRACT

An electric energy control device includes: a measuring device to measure an electric current; a voltage sensor to measure an electric voltage; and a power calculation unit which receives current information from the current sensor and voltage information from the voltage sensor, and is configured to calculate the electric power consumed at the power output of the electric meter. The device also includes a control member which receives information concerning the electric power consumed from the power calculation unit, calculating the difference between the electric power information item and a preceding value, if an absolute value of the difference being less than the threshold remaining idle and if an absolute value of the difference being greater than the threshold outputting a message containing a power value to a terminal for recharging an electrical storage battery. The recharging terminal being remote from the measuring and control members.

### FIELD OF THE INVENTION

The invention relates to the field of recharging batteries, particularly of electric vehicles.

### BACKGROUND

The recharging of electric vehicles, more generally of stationary or mobile batteries, puts significant pressure on electrical grids. Upstream of electric meters, grid reinforcements may be provided in dense areas. Downstream of electric meters, the question arises of the power supply of various electrical energy consumers.

The Applicant endeavors to meet the need for improved control of the downstream of an electric meter.

The Applicant has designed an energy control apparatus that makes it possible to optimize the operation of terminals for recharging electric vehicles. This apparatus is named “Qometer”.

Electric vehicle (EV) recharging terminals may be installed behind a dedicated meter as well as an existing meter. In the case of an installation behind an existing meter, the recharging terminals share the power available at the meter with the other apparatuses using the same electricity contract.

A fundamental problem then arises related to the power of a recharging terminal that may very easily reach:
7.4 kW (32 A×230 V) in the case of a single-phase installation
22 kW (32×230 V×3) in the case of a three-phase installation

Yet a recharging terminal at full power may trip the entire electrical installation of which the contract taken out is limited. By way of example, in France, in an individual house supplied in single-phase, the maximum contract power is 12 kVA (kW).

In order to prevent the recharging terminal from tripping the electrical installation, recharging terminal installers may act on 3 parameters:

1. The contract power at the meter
2. The recharging time slot
3. The maximum power of the recharging terminal

These three parameters are independent but none of them can provide a 100% guarantee of the correct operation of the recharging terminal in all circumstances.

The solution globally adopted by installers indeed involves increasing the contract power at the meter, delaying the recharging time of the EV to late hours of the night where other apparatuses reduce their consumptions, and restricting the maximum power of the charger.

All of these modifications are static changes. This means that in case of change (even temporary) of the habits of the consumer or of the addition of new electrical apparatuses, the recharging of the EV may lead to the tripping of the meter.

Some modern meters make it possible to know, by means of the access to a communication port, the instantaneous consumption of the meter. However, not all meters are equipped with this function and in addition, when such a communication function exists, the communication standard differs from one meter model to another and from country to country.

Moreover, the meters, known as “smart”, communicate in Slave mode. This means that a third-party apparatus (Master) is responsible for launching a request to know the power of the meter.

Even if a recharging terminal can connect to the communication port of a meter, if the recharging terminal wants to adapt its power depending on the power remaining at the meter, the recharging terminal must regularly query the meter. If, between two queries, the power of the meter suddenly increases, the maximum contract power may in practice be exceeded. This means that, for a correct operation, the recharging terminal must query the meter at a higher frequency. This solution has two drawbacks:

1. First of all, it is not certain that the meter (even known as smart) can support too high a query frequency.
2. In addition, too high a query frequency creates a high communication volume, not necessarily compatible with the capacity of the communication link.

In any event, it is to meet this fundamental need of automatically adapting the power of the recharging terminal to the power available at the meter that the electric device for energy control has been created.

### SUMMARY

The electric device for energy control comprises a plurality of modules:
Energy measuring module: this module calculates the instantaneous power by measuring the intensity and the voltage at the main meter without introducing outages at the main electrical circuit and independently of the main meter.
Communication module: this module uses a communication protocol of the LAN type (Ethernet, Wi-Fi, HomePlug CPL, Bluetooth, etc.) to establish a communication with the recharging terminal.
Control module: consisting of a microcontroller, this module queries (via an analogue-digital link) at a relatively high frequency the energy module (above) and only transmits a new power value to the recharging terminal (via the communication module) if the variation of the instantaneous power exceeds a certain threshold set by the manager of the system.

The modules may be produced in a software way.

Thus, the electric device for energy control makes it possible for the recharging terminal to automatically adapt its power depending on:
the contract power at the meter,
the instantaneous total power used by all of the apparatuses of the electrical grid using this same meter, including the recharging terminal itself.

The electric device for energy control therefore makes it possible to optimize the power of the recharging terminal, to minimize the charging time and to protect under varied circumstances the main meter against a tripping risk.

Generally, the electric device for energy control comprises a measuring member comprising a current sensor configured to measure an electric current downstream of the power of a low-voltage electric meter, a voltage sensor configured to measure an electric voltage at the power output of the low-voltage electric meter, and a power calculation unit receiving current information from the current sensor and voltage information from the voltage sensor, and being configured to calculate the electric power consumed at the power output of the electric meter. The electric device for energy control comprises a control member receiving information of electric power consumed from the power calculation unit, calculating the difference between said information of electric power consumed and a preceding value, comparing the absolute value of said difference with a threshold, in case of an absolute value of said difference being less than the threshold remaining idle and in case of an absolute value of said difference being greater than the threshold outputting a message containing a power value to a terminal for recharging an electrical energy storage battery, the recharging terminal being remote from the measuring member and the control member, said preceding value being said power value contained in the preceding message.

In one embodiment, the measuring member and the control member have a common housing. The common housing houses the control member and a power calculation unit of the measuring member.

In one embodiment, the control member comprises a communication member configured to establish a link at least one-way to the recharging terminal.

In one embodiment, the recharging terminal is configured to receive said message and adapt its energy consumption to the difference between a contract power and the power value contained in said message.

The calculation of the difference between a contract power and the power value may also be carried out at the control member. In this case, it is the new power at which the charger must operate that is transmitted to it. It is also possible that there is communication with a central server that controls by default the charger.

In one embodiment, a slave recharging terminal is controlled by said control member.

In one embodiment, said threshold is greater than or equal to 1% of the contract power.

In one embodiment, the frequency for comparing the absolute value of said difference with said threshold is less than or equal to 100 Hz.

In one embodiment, said message is output at a frequency at least 10 times less than the frequency for comparing the absolute value of said difference with said threshold.

In one embodiment, the calculation of the difference between a contract power and the power value is performed by the control member, the new power at which the charger must operate being transmitted to said charger.

In one embodiment, said communication with a central server controlling by default the charger is established by the control member.

In one embodiment, the control member is configured to output a message containing a power value to each terminal for recharging an electrical energy storage battery connected to said device, each recharging terminal being remote from the measuring member and the control member, said preceding value being said power value contained in the preceding message.

In one embodiment, the electric device for energy control and/or said server implements artificial intelligence functions to optimize the distribution of powers in the case of simultaneous management of a plurality of recharging terminals.

In one embodiment, the electric device for energy control comprises a charge distribution member between phases of a three-phase low-voltage electric meter.

In one embodiment, the electric device for energy control is devoid of communication link with the electric meter.

### BRIEF DESCRIPTION OF THE DRAWINGS

Other specific features and advantages of the invention will be described in detail in the following description, made with reference to the appended drawings, wherein:

FIG. 1 is a schematic view of a device according to one aspect of the invention.

FIG. 2 is a schematic view of a device according to another aspect of the invention.

FIG. 3 is a detail view of the housing.

The appended drawings mainly contain elements of certain character. Therefore, not only may they be used to better understand the present invention, but also to help to define it, if necessary.

### DETAILED DESCRIPTION OF THE PREFERRED EMBODIMENTS

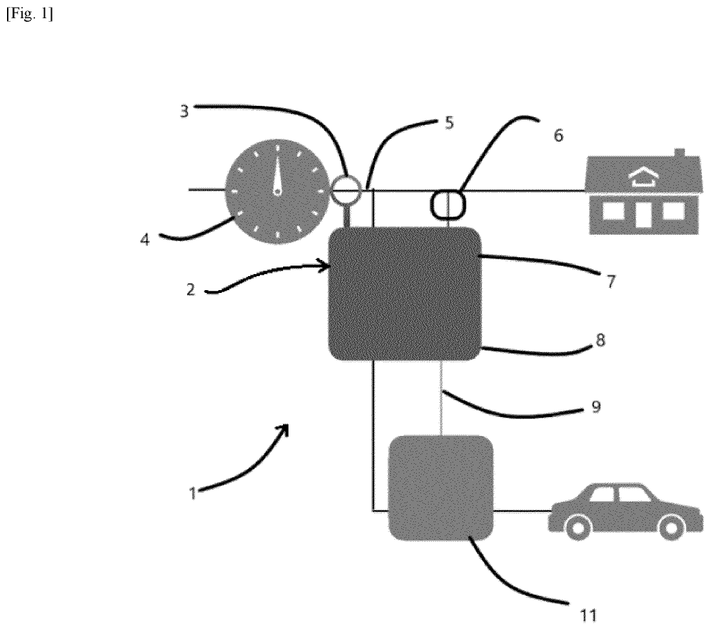

As illustrated in FIG. 1, the electric device for energy control is provided to come to connect on an electrical installation, existing as well as to be created. The electrical installation may be a domestic or small company installation. The electrical installation comprises an electric meter 4 connected to the low-voltage mains ensuring the power supply, for example in 110 or 220 volts, 50 or 60 Hz, single- or three-phase. The electrical installation comprises a local power distribution network 10 supplying the consumer members by electrical wires, including a terminal for recharging an electrical energy storage battery.

The electric device for energy control 1 comprises a measuring member 2 adapted to the local area network. The measuring member 2 comprises a current sensor 3 configured to measure an electric current at the power output of a low-voltage electric meter 4. The current sensor 3 may comprise a measuring loop around the electrical wires 5 of the electric meter 4. The current sensor 3 is disposed close to the electric meter 4 upstream of line connections, distribution boxes and consumer members. The current sensor 3 is different from the electric meter 4. The electric device for energy control 1 is different from the electric meter 4. The electric device for energy control 1 is devoid of communication with the electric meter 4.

The measuring member 2 comprises a voltage sensor 6 for measuring an electric voltage at the power output of an electric meter 4. The voltage varies from a few percent around the rated voltage. It is preferable to measure it with an accuracy better than the delivery accuracy. The voltage sensor 6 is different from the electric meter 4.

The measuring member 2 comprises a power calculation unit 7 receiving current information from the current sensor 3 and voltage information from the voltage sensor 6. The power calculation unit 7 is configured to calculate the electric power consumed at the power output of the electric meter 4. The power calculation unit 7 performs the product of the current value measured by the voltage value measured. The measuring member 2 comprises a control member 8 receiving the electric power consumed value from the power calculation unit 7. The control member 8 calculates the difference between said electric power consumed value and a preceding value. The control member 8 compares the absolute value of said difference with a threshold, and in case of absolute value of said difference being less than the threshold remains idle. In case of absolute value of said difference being greater than the threshold, the control member 8 outputs a message containing a power value to the terminal 11 for recharging an electrical energy storage battery. Said preceding value is said power value contained in the preceding message. The threshold may be set at 1% of the contract value of the contract with the electrical energy supplier or at a higher value. The comparison of the absolute value of said difference with said threshold is performed regularly. The comparison of the absolute value of said difference with said threshold is performed at predetermined intervals, for example at a frequency less than or equal to 100 Hz.

The output of said message by the control member 8 is performed at a frequency at least 10 times less than the frequency for comparing the absolute value of said difference with said threshold. Said message is output less than 10 times per second.

The recharging terminal 11 is remote from the measuring member 2 and the control member 8. Said message may be sent over a LAN network 9. The calculation unit 7 and control member 8 may be produced with the aid of a microcontroller.

The calculation of the difference between a contract power and the power value may also be carried out at the control member 8. In this case, it is the new power at which the charger must operate that is transmitted to said charger. It is also possible to implement a communication with a central server that controls by default the charger.

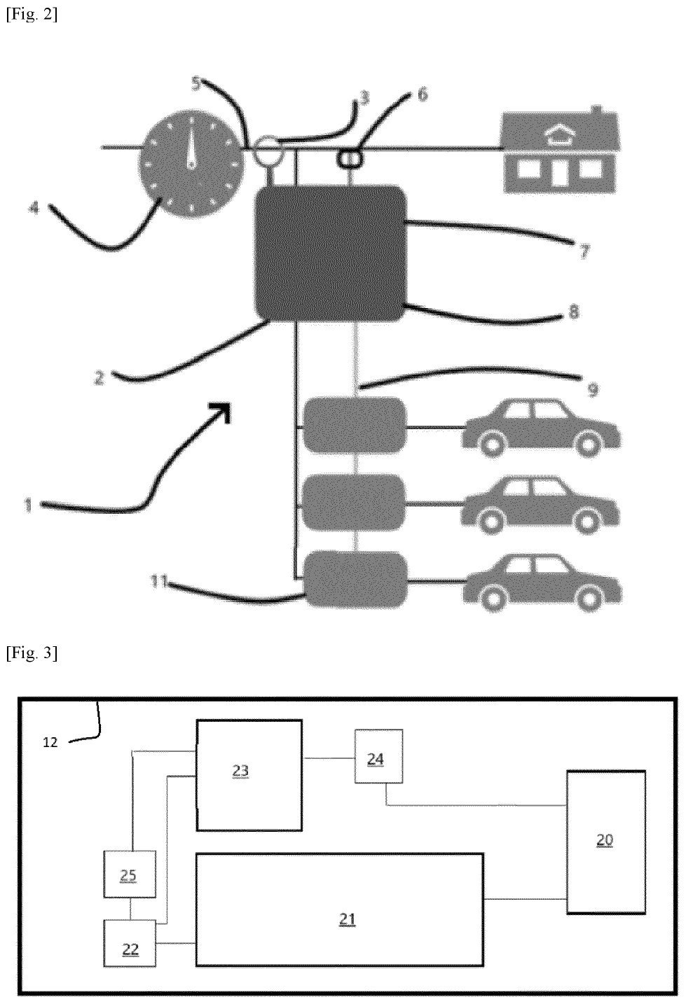

In the embodiment of FIG. 2, a plurality of recharging terminals 11 are supplied from the same electric meter 4.

A recharging terminal, slave, may be controlled by said control member 8. As a variant, a recharging terminal may be controlled by said control member 8 via another recharging terminal.

FIG. 3 illustrates an example of embodiment of the electric device for energy control 1. The measuring member 2 is equipped with a housing 12 housing and protecting the power calculation unit 7 and the control member 8. The current 3 and voltage 6 sensors are disposed outside of the housing 12.

The measuring member 2 comprises, inside the housing 12, at least one connector 20, particularly a connector in single-phase version and two connectors in three-phase version, ensuring the link with the mains for the power supply of said housing 12, with the recharging terminal or terminals 11 and with the current 3 and voltage 6 sensors. The measuring member 2 comprises a power transformer 21 connected by the intermediary of the connector 20 to the leads of the electric meter 4. The power transformer 21 may be of the 230/5 volts or 110/5 volts type. The measuring member 2 comprises a rectifier 22 supplied by the power transformer 21. The rectifier 22 may comprise a diode bridge.

The measuring member 2 comprises a carrier current communication device 23 supplied by the rectifier 22 and connected to the leads of the electric meter 4 to thus communicate with the recharging terminal or terminals 11. The communication member 23 establishes a link at least one-way to the recharging terminal 11. The link is a link at least one-way and preferably two-way. The recharging terminal 11 receives the message output by the control member 8 and transmitted by the communication member 23. The recharging terminal 11 adapts its energy consumption to the difference between a contract power and the power value contained in the message. Alternatively, the communication of the measuring member 2 to the recharging terminals 11 may be performed by the LAN network. The measuring member 2 comprises a galvanic isolation member 24 mounted between the connector 20 connected to the leads of the electric meter 4 and the communication member 23. The galvanic isolation member 24 comprises, for example, a photodiode.

The measuring member 2 comprises a processor 25 connected to the connector 20 to receive the measurement information from the current 3 and voltage 6 sensors and to output at least one instruction, particularly in the form of a message, to at least one recharging terminal 11. The processor 25 is pre-programmed to fulfil the functions of processing current and voltage and control measurements. The processor 25 is supplied by the rectifier 22.

The control member may be configured to output a message containing a power value to each terminal for recharging an electrical energy storage battery connected to the electric device for energy control. Each recharging terminal is remote from the measuring member and the control member. Said preceding value is said power value contained in the preceding message.

In one embodiment, artificial intelligence functions are implemented by the electric device for energy control and/or by said server. The artificial intelligence functions are provided to optimize the distribution of powers in the case of simultaneous management of a plurality of recharging terminals, according to FIG. 2.

Moreover, many low-voltage electric meters are three-phase. In this case, the electric device for energy control may comprise a charge distribution member between the phases. This is all the more interesting as the distribution between the phases of a network downstream of a meter is often fixed and unsuitable.

1. Electric device for energy control comprising a measuring device comprising a current sensor configured to measure an electric current downstream of a low-voltage electric meter, a voltage sensor configured to measure an electric voltage at the power output of the low-voltage electric meter, and a power calculation unit receiving a current information from the current sensor and a voltage information from the voltage sensor, and being configured to calculate the electric power consumed at the power output of the electric meter; and a control member receiving information of the electric power consumed from the power calculation unit, calculating the difference between said information of electric power consumed and a preceding value, comparing the absolute value of said difference with a threshold, in case of an absolute value of said difference being less than the threshold remaining idle and in case of an absolute value of said difference being greater than the threshold outputting a message containing a power value to a terminal for recharging an electrical energy storage battery, the recharging terminal being remote from the measuring member and the control member, said preceding value being said power value contained in the preceding message.

2. The device according to claim 1, wherein the measuring member and the control member have a common housing.

3. The device according to claim 1, wherein the control member comprises a communication member configured to establish a link at least one-way to the recharging terminal.

4. The device according to claim 1, wherein the recharging terminal is configured to receive said message and adapt its energy consumption to the difference between a contract power and the power value contained in said message.

5. The device according to claim 4, wherein a slave recharging terminal is controlled by said control member.

6. The device according to claim 1, wherein said threshold is greater than or equal to 1% of the contract power.

7. The device according to claim 1, wherein the frequency for comparing the absolute value of said difference with said threshold is less than or equal to 100 Hz.

8. The device according to claim 1, wherein said message is output at a frequency at least 10 times less than the frequency for comparing the absolute value of said difference with said threshold.

9. The device according to claim 1, wherein the calculation of the difference between a contract power and the power value is performed by the control member, the new power at which the charger must operate being transmitted to said charger.

10. The device according to claim 1, wherein a communication with a central server controlling by default the charger is established by the control member.

11. The device according to claim 1, wherein the control member is configured to output a message containing a power value to each terminal for recharging an electrical energy storage battery connected to said device, each recharging terminal being remote from the measuring member and the control member, said preceding value being said power value contained in the preceding message.

12. The device according to claim 1, wherein the electric device for energy control implements artificial intelligence functions configured to optimize the distribution of powers in the case of simultaneous management of a plurality of recharging terminals.

13. The device according to claim 1, wherein the electric device for energy control comprises a charge distribution member between phases of a three-phase low-voltage electric meter.

14. The device according to claim 1, wherein the electric device for energy control is devoid of communication link with the electric meter.
